(19) United States
(12) Patent Application Publication
(10) Pub. No.: US 2005/0138349 A1
(43) Pub. Date: Jun. 23, 2005

(54) Metering keys in partitioned computer systems

(76) Inventors: Philip M. Hoffman, Oreland, PA (US); Stuart M. Smith, Kimberton, PA (US); David J. Kasarsky, Boothwyn, PA (US); Peter J. Hancock, Ramsey, MN (US); Jessica Paragas, Springfield, PA (US)

Correspondence Address: Michael B. Atlass;Unisys Corporation, Unisys Way, MS/E8-114, Blue Bell, PA, 19424-0001, US

(21) Appl. No.: 10/744,446

(22) Filed: Dec. 23, 2003

(51) Int. Cl. H04L 9/00; G06F 17/00

(52) U.S. Cl. 713/150; 709/223; 705/400

(57) ABSTRACT

A method and system for a partitioned computer system includes the establishment of a computer system where each partition is given an economic value determined by the value of the task to be performed and the processing power assigned to perform the task. The sum of all partitions within the system establishes a fixed economic value for the partitioned system. Billing for utilized processor performance within each partition may be performed in relation to rates established for each partition. Each partition may be assigned a metering key which enables metering and reporting of the processor performance utilization of each partition. Billing reports for each partition may be generated and sent via electronic mail along with a digital signature for each partition to a central billing authority for processing.

### REFERENCE TO CO-PENDING APPLICATIONS

The following co-pending application has some subject matter in common with the current application:

Attorney docket number RA-5660 entitled “System and Method for Metering the Performance of a Data Processing System”

The following co-pending applications have substantially identical specifications but different claims than the current application:

Attorney docket number TN301A entitled “Method for Economic Valuation in Partitioned Computer Systems”; and

Attorney docket number TN301B entitled “Method and System for Performance Redistribution in Partitioned Computer Systems”.

### FIELD OF THE INVENTION

The current invention relates generally to data processing systems, and more particularly to methods for the monitoring of performance of data processing systems.

### BACKGROUND OF THE INVENTION

Many businesses are challenged with ensuring that their data processing systems keep pace with expanding and peak demands. As a result, data processing systems have been developed that have adaptable performance mechanisms for providing additional performance when needed. Commonly-assigned U.S. patent application entitled “Authorization Key System for Selectively Controlling the Performance of a Data Processing System”, Ser. No. 09/676,162 filed Sep. 29, 2000, and which is incorporated herein by reference in its entirety, discloses an exemplary system employing processor keys to assist in the adaptation of system resources to user needs.

Other adaptive data processing systems have been developed that utilize hardware and software elements constructed to accommodate a partitioning of the computer system for multiple user purposes. A partitioned system may be established as a result of a contract for computer services between a business user and a computer supplier. A partition is a grouping of resources that are allocated to execute in a cooperative manner to perform one or more assigned tasks. Each partition determined in the contract may specify an instruction processor (IP) performance level so that a business user can apply the partition to computing tasks that his business needs to perform.

For example, a partition may be formed that includes one or more predetermined instruction processors (IPs) and Input/Output Processors (IOPs), and a predetermined memory range within a shared main memory. A second partition may be created to include different processors, IPs and IOPs, and another memory range. Each of these partitions may operate independently from the other so that a number of tasks may be executed in parallel within the system. When a system needs to be changed to adapt to a changing business requirement, the partitions can be redefined. For instance, if needed, all resources may be allocated to the same partition and assigned to execute a single high-priority task.

Billing the user business for the processor performance that is utilized in partitioned systems may be accomplished by measuring the performance and applying a fixed billing rate for the partition use. However, reporting usage and billing at a fixed rate for any partition may become complicated by the fact that a high priority or high value tasks may be moved by a user from a high priority, high rate partition to a low rate partition. The current prior art systems do not account for the value that a business user places on any of the tasks performed within a partition. As a consequence, current processor performance meters cannot not take into account the business value of the processing tasks with respect to the performance utilized in any one partition.

Another challenge faced by metering and billing systems is fraud. Some current metering systems are not well protected from processor performance piracy by the users. By adjusting metered utilization figures, it may be possible for fraud to occur in the reporting of processor utilization. Fraudulent utilization metering may result in inaccurate billing.

Thus, there is a need for a method in partitioned computer systems to value the processing tasks performed in a partition and to prevent fraud in measuring processor performance. The present invention addresses the aforementioned needs and solves them with additional advantages as expressed herein.

### SUMMARY OF THE INVENTION

A data structure for a metering key is disclosed where the key includes a first data field containing identification information such that the identification information uniquely identifies at least one partition for a computer system. A second data field contains a processor baseline performance value and a third data field containing a billing code for the partition. The metering key is used to enable reporting of measured processor performance in the at least one partition and is correlated with the billing code corresponding to a relative economic value of the partition in the computer system.

A method of monitoring processor utilization in a computer comprising multiple partitions includes assigning each partition a baseline performance value and a relative value. The relative value includes a value of a class of tasks performed in the partition relative to the values of classes of tasks performed in each other partition. The product of the baseline performance value and the relative value of the partition define an economic value for the partition. The sum of the economic values of all the partitions defines a total economic value for the computer. A digital metering key is associated with each partition. The digital metering key enables the measure of processor utilization within one of the partitions. The metered performance may then be reported using a digital signature to authenticate the data reported. Other partitions of the computer system may be measured and reported similarly.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of an exemplary system that may employ the current invention;

FIG. 2A is a diagram of an exemplary partitioned computer system;

FIG. 2B is a diagram of a modified exemplary partitioned computer system; and

FIG. 3 is a flow diagram describing a method of the invention.

### DETAILED DESCRIPTION OF ILLUSTRATIVE EMBODIMENTS

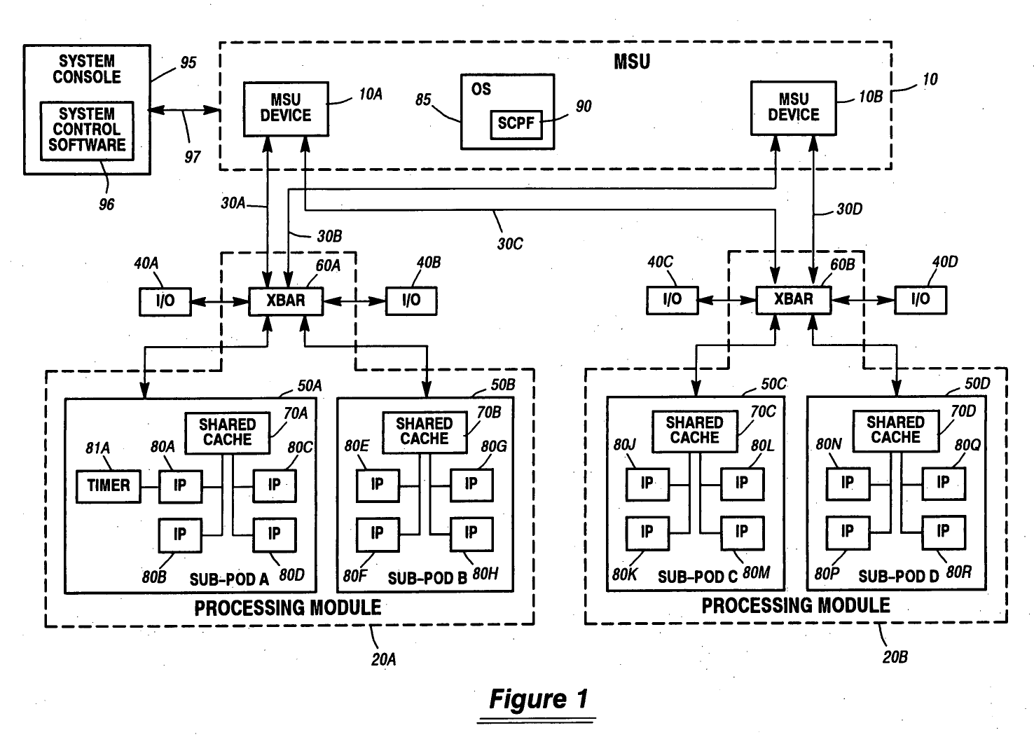

FIG. 1 is a block diagram of an exemplary system that may employ the current invention. This system includes a Memory Storage Unit (MSU) 10 (shown dashed) which provides the main memory facility for the system. The MSU includes one or more MSU devices individually shown as MSU 10A and MSU 10B, which each contains a predetermined portion of the memory space of the system. Many more MSU devices may be included within a full configuration.

The system further includes processing modules (PODs) 20A and 20B (shown dashed), which provide the processing capability for the system. A greater or lesser number of PODs may be included in the system than are shown in FIG. 1. In one embodiment, up to four PODs are included in a fully populated system.

Each of the PODs is coupled to each of the MSU devices via a dedicated, point-to-point connection referred to as an MSU Interface (MI), individually shown as MIs 30A through 30D. For example, MI 30A interfaces POD 20A to MSU device 10A, and MI 30B interfaces POD 20A to MSU 10B device. Other MI units are similarly interfaced to other PODs.

Each POD includes two sub-processing modules (Sub-PODs) and a crossbar module (XBAR). For example, POD 20A includes sub-PODs 50A and 50B and XBAR 60A. Other PODS and XBARS are similarly configured. Each sub-POD is interconnected to the respective crossbar module (XBAR) through a dedicated point-to-point interface.

The system of FIG. 1 may further include Input/Output modules (I/Os) individually shown as I/Os 40A through 40D. The I/O modules provide the interface between various Input/Output devices or communications links and a respective one of the PODs 20. Each I/O module is coupled to a POD via the POD's XBAR. For example, I/O 40A is coupled to XBAR 60A. XBAR 60A buffers data for the respective sub-PODs 50A and 50B and I/O modules 40A and 40B and functions as a switch to route data between any of these sub-PODs and I/O modules to an addressed one of the MSU devices 10A and 10B.

In the exemplary system of FIG. 1, each sub-POD includes a shared cache and one or more Instruction Processors (IPs). For example, sub-POD 50A includes shared cache 70A and IPs 80A-80D. Other sub-PODs are similarly configured. In one embodiment, a sub-POD 50 may include between one and four IPs 80. Each IP may include one or more dedicated caches and interface logic for coupling to the interface with the shared cache. The shared cache stores data for each of the IPs within its sub-POD. Finally, each IP includes a quantum timer shown as timer 81A for IP 80A. This timer has many uses, including the facilitation of multi-tasking for the respective IP.

The system of FIG. 1 includes at least one instance of an Operating System (OS) that is loaded into MSU 10 to control the system. OS 85 is shown generally occupying memory included within MSU 10, and it will be understood the selected memory range in which OS 85 resides will actually be provided by one of MSU devices 10A or 10B.

Also shown residing with MSU 10 is at least one instance of a Software Controlled Performance Facility (SCPF) 90. The SCPF may be implemented in the kernel of OS 85 as shown in FIG. 1, or implemented as a stand-alone entity. In either case, the SCPF controls the performance level of each of the IPs 80 within the system.

Finally, the system of FIG. 1 includes a system console 95, which may be a workstation, personal computer, or some other processing system executing system control software 96. This system console is coupled to the other units in the system via a scan interface 97. Although for simplicity, the scan interface is shown coupled solely to MSU 10, it will be understood it is coupled to the other units in the system as well. System console 95 provides all initialization, maintenance, and recovery operations for the system via the scan interface. In addition, system console 95 may be employed by an operator to perform configuration activities.

The architecture of FIG. 1 may be utilized to construct a system of multiple partitions within a data processing system. A partition is a grouping of resources that are allocated to execute in a cooperative manner to perform one or more assigned tasks. For example, a partition may be formed that includes one or more predetermined instruction processors (IPs) and Input/Output Processors (IOPs), and a predetermined memory range within a shared main memory. A second partition may be created to include different IPs, IOPs, and another memory range. Each of these partitions may operate independently from the other so that a number of tasks may be executed in parallel within the system. When system needs change, the partitions can be redefined by the system provider or by the user of the system. For instance, if needed, all resources may be allocated to the same partition and assigned to execute a high-priority task.

It will be appreciated that the system of FIG. 1 is merely provided as an example computing environment in which the present invention may operate. Any other data processing system having any other type of configuration may usefully employ the inventive system and method to be discussed in the following paragraphs. With the foregoing available for discussion purposes, the current invention is described in regards to the remaining drawings.

Economic Value

The concept of economic value as used in computer system performance apportionment and monitoring is introduced by way of example in a structure of a partitioned system. In one embodiment of the invention, partitions used in a computer system may be created to perform different tasks. The creation of these partitions may be defined in a contract of sale for the use of processor performance within the computer system. The tasks performed within the partitions have a business value to the computer performance purchaser. This business value may be apportioned according to the value of the task in relation to the business being conducted. For example, in a manufacturing business, if processing power is needed for a prime, revenue generating function such as manufacturing, then a partition may be generated to handle processing tasks related to manufacturing tasks. Another task of the business may be that of keeping track of orders and related accounting. Therefore a partition may be generated that is addressed to order processing and related accounting tasks. Yet another task of the business may be that of generation of new products via engineering tasks. Therefore, a partition may be generated that supports the processing of an engineering function within the business.

Each partition of the computer system, for the example manufacturing business mentioned above, has a relative value compared to the most important task of the business. In the example of a manufacturing business, the order of priority in tasks for the business may be manufacturing, then accounting, then engineering. In relative terms, the functions may be valued as:

| | |
|---|---|
| Manufacturing | 1.0 |
| Accounting | 0.5 |
| Engineering | 0.3 |

The metrics of 1.0, 0.5 and 0.3 may represent relative economic values of the tasks of the manufacturing business. In this instance, the three computer partitions may be constructed corresponding to the revenue generating value of each partition. Naturally, other relative value determinations, not based on revenue, may also be made.

Each partition has an associated task and each task must be assessed so as to size the performance value of the partition. One standard of computing power is measured in MIPS (million instructions per second). Thus, the partitions may be allocated a MIPS value based on an assessment of the need for processing the task associated with the partition. In the manufacturing business example, the manufacturing, accounting, and engineering tasks may require processing performance of 500, 250 and 250 MIPS respectively.

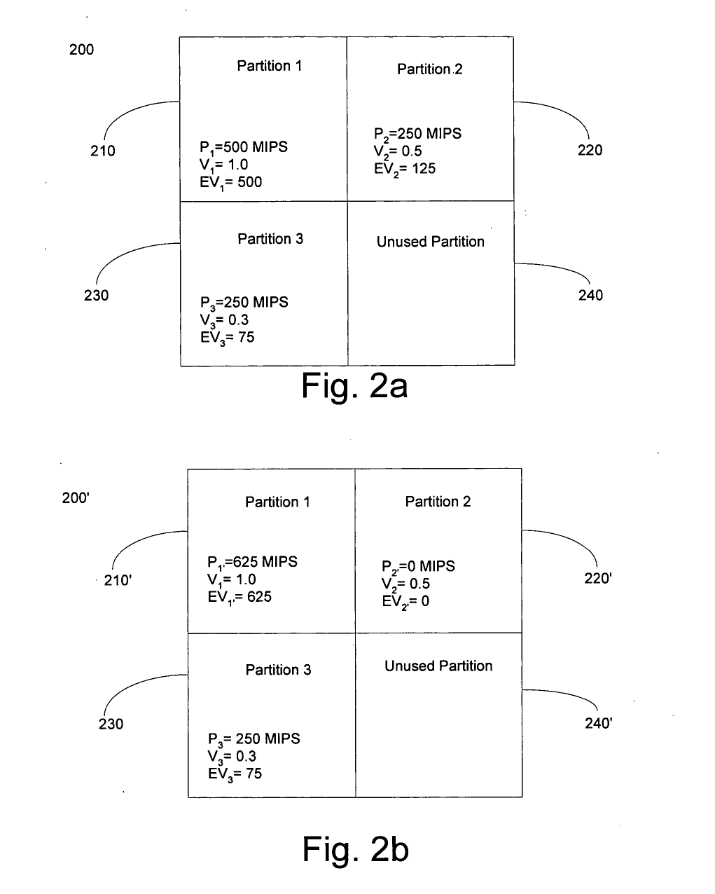

FIG. 2a represents the partitioned system 200 architected for the exemplary manufacturing business. The first partition, 210, represents the manufacturing task. Partition 1 has a processing power P₁ of 500 MIPS and relative value V₁ of 1.0. A relative economic value (EV₁) for partition 1 is the product P₁V₁. Thus, in this example, partition 1 has an economic value of 500.

The second partition 220 represents the accounting task. Partition 2 has a processing power P₂ of 250 MIPS and relative value V₂ of 0.5. A relative economic value (EV₂) for partition 2 is the product P₂V₂. Thus, in this example partition 2 has an economic value of 125.

The third partition, 230 represents the engineering task. Partition 3 has a processing power P₃ of 250 MIPS and relative value V₃ of 0.3. A relative economic value (EV₃) for partition 3 is the product P₃V₃. Thus, in this example, partition 3 has an economic value of 75. Although processing capability for another partition may exist in the exemplary manufacturing computer, the additional capability may remain unused 240.

The sum of the economic values of each partition equals the economic value of the entire system (P₁V₁+P₂V₂₊P₃V₃=EV_{system}). In the current example, the economic value of the system totals to 700.

According to one aspect of the present invention, once established by a contract between a computer system seller and a customer, the economic value of the system remains fixed unless subsequent arrangements are made between the seller and customer to increase the total economic value of the system. Once a total economic value of a system is established by contract, even if the system user redistributes the tasks between and among partitions, the total economic value of the system does not change. In other words, the user may redistribute tasks between and among the partitions of a system, but must do so within the constraints of the established total economic value of the system such that the total economic value is not exceeded. However, the economic value of the system may change when a system user purchases more or less IP performance in any one of the existing partitions or in a new partition.

The economic value concept of the present invention can be used in connection with billing of performance utilization within the computer system. Each partition may be equipped with a monitoring scheme such that a billing rate is keyed to the relative value of the partition. Thus for example, partition 2, with a relative value of 0.5, may be billed at half the rate as partition 1 which has a relative value of 1.0.

Even if the user moves tasks from one partition to another to accommodate changes in business processing needs, the economic value of the system is preserved and billing is preserved according to the relative value of the partitions. A numerical example of a change in partitions is illustrative of the advantage.

Referring to the partitioned system 200′ of FIG. 2b, if a user wished to move the processing tasks and capability of the second partition 220′ into the first partition 210′, then partition 1 may gain processing responsibility if partition 1 is not already at its maximum performance level. However, the addition of a new performance ceiling on Partition 1 of FIG. 2b comports with the principle of fixed economic value for a given system.

Even though the ceiling performance of partition 2 was 250 MIPS, only the equivalent economic value of partition 2 may be moved to partition 1. In the case of FIG. 2b, the breakdown of the economic value of the new first partition 210′ is: P_{1′}V_{1′}=P₁V₁₊P₂V₂=(500×1.0)+(250×0.5)=625

and the economic value of the second partition EV_{2′} is reduced to zero. Note that the economic value of the system is preserved at P_{1′}V_{1′+}P_{2′}V_{2′+}P₃V₃=EV_{system}=625+0+75=700 as before.

In terms of billing, the billing rates for the three partitions of FIGS. 2a and 2b may be the same as originally established both before and after the performance redistribution. The only difference is that there is more performance to bill at the first partition rate and zero performance to bill at the second partition rate. The third partition rate and volume remains unchanged.

Partitioned systems may have restrictions placed upon them that allow the system vendor to limit the moving of some tasks from some partitions to another partition. A partition may be configured to throttle the total amount of performance redistribution from one specific partition to another partition. This allows a partition to perform more than one class of tasks but limit the amount of multiple class tasks that may be performed in a single partition. Alternately, the system vendor may prohibit completely the moving of tasks into a specific partition such that one partition performs only one class of tasks and not others.

System Process

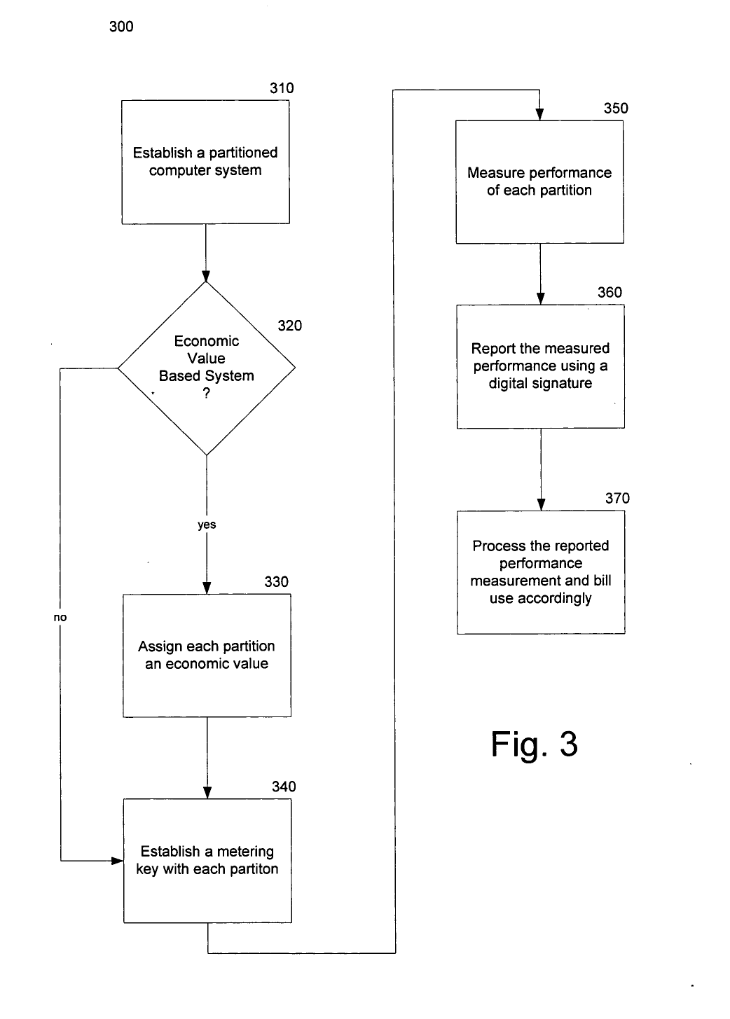

FIG. 3 illustrates a flow diagram 300 of a process of the present invention. Initially, a computer system is partitioned (step 310). This may preferably occur at the time a contract for the sale of a computer system is generated. The computer provider would desirably negotiate with a potential system user or purchaser, and architect the computer system according to the purchaser's business needs. Next, a decision (step 320) as to whether the partitioned computer system is to have an economic value assigned to it or not is made. If a system is not to have an economic value assigned to it, it may be a fixed price system and partition level performance metering (step 340) may still be desired. However, if an economic value is to be assigned to the system and partition level metering is desired, then an economic value may be assigned (step 340) to each partition.

The computer system provider may assign an economic value to each partition (step 340) according to aspects of the invention. This step would involve selecting an appropriate performance level (P) for each partition. For example, performance may be established in MIPS. In other embodiments, other measures of performance may be used. The system provider would also assign a relative value (V) to each partition so as to establish an economic value to a class of tasks associated with each partition (P times V=Economic Value). The resulting system would then have a total economic value representing the sum of all of the economic values of the individual partitions of the system.

The deployed system may then have its performance metered (step 340) to determine the utilization of processor performance in each partition. This partition metering may be performed using unique metering keys. In one embodiment, a metering key identifies the system, the partition, the reporting interval and duration, a ceiling and base performance values of the partition as established by the contract between the seller and user, and a billing code. If a system user has moved processing tasks from one partition to another, the metering keys may accommodate the redistribution and an accurate measurement of metering within each partition may still be accomplished. In a system which does not have an economic value assigned, the same metering key may be used absent information indicative of economic value.

Once a partition processor performance utilization is metered, a report is generated (step 350) and sent to a central billing authority. The report preferably utilizes electronic mail as the delivery technique. In other embodiments, other forms of delivery may be used.

Preferably, the report incorporates a digital signature. The digital signature serves to authenticate the source and content of the partition report as being valid. Once the report is received by the central billing authority, the authority processes the digital signature and verifies that the source and content of the report are valid for reduction of possible reporting fraud.

The validated report is then processed (step 360) such that a bill may be generated for the system user. The processing of the report may include accumulating reports from some or all of the partitions which are included in the system as specified in the contract. Each partition may be processed for billing by using a billing code in each partition report and associating that billing code with a billing rate established by the contract. A final bill may then be sent to the system user representing the performance utilization in the reporting interval for each of the billable uses of each system partition. As an alternative to sending a bill to a system user, the billing authority can equivalently debit a system users payment account in an amount commensurate with the billable metered performance utilization. Such a debit may be set up to occur automatically, or with the authorization of the account holder, such as is common with credit card transactions.

Metering of Processor Utilization

In one embodiment of the invention, a metering method comprises measuring the performance in each partition of a computer system using metering keys, compiling the results for each partition at a single location, and billing the computer system user according to the performance utilized.

A performance meter may gather and average actual processor utilization for each active partition. The associated workload utilization may be a function of the actual processor configuration (both IP count and location), the performance level of each processor, and the actual processor utilization. This workload information is accumulated, recorded, and periodically reported to a central billing location. In one embodiment, the reporting of metering may take the form of reports and billing may occur according to a billing code within a metering report. Metering and reporting may occur according to a metering key associated with each system.

A metering key is a software-based workload metering guide that establishes the overall metering characteristics that match the terms of the contract drawn up between the system manufacturer or seller and the system user or customer. Thus, all metering parameters are established by the performance characteristics imbedded in the active metering key. The metering key may also include basic partition information useful for both enabling functionally of the partition and controlling processor performance within a partition.

Table 1 depicts an exemplary structure of a metering key in one embodiment of the current invention. Processor performance metering may be enabled using metering keys with fields that describe the metering reporting date, the recording interval, the reporting interval, and the overall baseline performance for each partition over which processor performance metering is accumulated.

TABLE 1
Metering Key Format

| Data | Description | Bits |
|---|---|---|
| Type | Type of Key | 4 |
| | 1 = permanent | |
| | 2 = temporary | |
| Version | Value = 4 | 4 |
| Images | Number of partition image licenses | 4 |
| MCN | Manufacturing Control Number (unique for each system) | 20 |
| Days | Number of days that a temporary key can be active | 10 |
| DR | Disaster Recovery = 1 | 1 |
| Reporting | Reporting day of month for metered utilization | 5 |
| Day | 0 = normal capacity management | |
| | 1-31 = metered utilization management | |
| Record | Recording interval in minutes | 7 |
| Interval | | |
| Meter Mode | Mode of Metering Key | 2 |
| | 0 = Credit Mode | |
| | 1 = Non-Credit Mode | |
| | 2 = Profile Mode | |
| Report | Automatic sending of report interval | 3 |
| Interval | 0 = Never | |
| | 1 = hourly | |
| | 2 = 2 hours | |
| | 3 = 4 hours | |
| | 4 = 8 hours | |
| | 5 = daily | |
| | 6 = monthly | |
| | <available> | 4 |
| Expiration | Key expiration (or 0) in Posix time DIV (24 * 60 * 60) format | 16 |
| Machine ID | 8 bit WATI machine type + 8 bit type modifier | 16 |
| Unique Key | Key creation Posix time (seconds since Midnight 1/1/1970); | 32 |
| ID | Unique Key ID used to mark use and prevent reuse of temporary | |
| | keys | |
| Partition | License image information for up to 4 partitions | 4 * 16 |

| | | |
|---|---|---|
| Image | Redundant | 1 bit |
| Descriptions | Price Point | 4 bits |
| | IP Performance Level | 6 bits |
| | Number of IPs-1 | 5 bits |

| | | |
|---|---|---|
| Partition | Base performance value in RPM for up to 4 partitions. Each base | 4 * 16 |
| Image Base | value is associated with the corresponding partition image | |
| | descriptor. | |
| Totals | | 256 |

Referring to Table 1, the metering key type (“Type”) may be either permanent or temporary. Permanent metering keys may be used to establish permanent (untimed) workload metering. Permanent metering keys can include an optional expiration date that might coincide with a contractual period. Permanent processor performance keys are used to establish initial system performance and future performance upgrades.

Temporary metering keys may be used to provide temporary (timed) performance upgrades for a specified number of days. Temporary keys may include the number of days and an expiration date (one year from the date of purchase of a system). These keys can be installed at any time because key timing starts when the keys are activated. Key timing may be in one-day increments, and customers can activate and deactivate these keys at any time. Meters only accrue against this type of key when the key is active. For example, a three-day temporary upgrade can be activated on the last day of January, February, and March. When the days of the temporary key are exhausted or the key expires, a previously established permanent key may be automatically activated. Once exhausted or expired, temporary metering keys cannot be reused.

The exemplary metering key of Table 1 depicts a fixed version value (“Version”) for the key, the number of image values (“Images”) corresponding to the number of partitions in the system, and a unique manufacturing control number (“MCN”) for the computer system identifying the metered system. The system type and manufacturing control number are used to associate a metering key with a specific system. A metering key can only be installed on one system. Normally, this system identification is used to establish the customer for whom metering information is being gathered.

Other fields of the key of Table 1 contain the number of days (“Days”) that the key can remain active and a bit designating the key as a special disaster recovery (“DR”) key. Disaster recovery keys may be used to provide temporary (timed) performance upgrades for disaster recovery over a specified number of days. Disaster recovery temporary keys include the number of days and an expiration date. These keys can be installed at any time because key timing starts when the key is activated. However, once activated, key timing continues until the specified number of days is exhausted. When the days of the temporary key are exhausted or the key expires, a previously established permanent key may be automatically activated. Once exhausted or expired, disaster recovery temporary keys cannot be reused.

The metering key of Table 1 also includes metering modes (“Meter Mode”) relative to billing of the measured processor usage. Instruction processor usage may generally be measured in the standard units of relative performance measure (RPM) or RPM seconds. RPMs may be defined as a workload performance measure analogous to MIPS. There are 24.3 RPM units in one MIP. Thus, in the examples which follow, MIPS can be used equivalently with RPM, given the linear conversion stated above. The metering key of Table 1 supports three types of metering key billing models: credit, non-credit, and profile.

The credit metering mode is used to calculate the billable RPM by subtracting the baseline performance from the actual performance utilization, for the reporting period. The baseline performance of the partition is generally established as a result of contract generation for the system. Using the credit metering model, the customer or system user will not be billed unless the actual performance utilization for the reporting period is greater than the baseline performance.

The non-credit metering mode is used to calculate the billable RPM by accumulating the actual performance utilization above the baseline performance level. Using this model, the customer will be billed for any utilization above the contracted baseline performance. Using the non-credit metering mode, the customer does not benefit from unused performance capacity.

The profile metering mode is a temporary mode that does not report billable performance in RPM. The purpose of this metering model is to gather usage information for a given customer. As with the credit and non-credit models, utilization may be stored and reported periodically, but no billable information is provided.

The Table 1 metering key also contains a reporting interval (“Report Interval”) to indicate the time interval between sending of reports. Metering reports will be discussed more fully below. The record interval represents the value over which partition metering information is gathered. The reporting day (“Reporting Day”) is the value that represents the settlement day of the month used for bill generation. Other fields include an expiration time (“Expiration”) for the key, a machine identifier (“Machine ID”) and a unique key identifier (“Unique Key ID”) that identifies the machine being reported and helps prevent fraudulent key use. The unique ID may be used to associate system-wide metering with a specific contract that has been negotiated with a customer. The contract preferably indicates the billing rate for each partition according to the economic value of the partition. This contract may have various metered rates and parameters that will be applied to meter reports that are sent from the metering system to a central billing location via e-mail. The metering key of Table 1 also defines the number of partitions (“Image Partition Descriptions”) for which metering contractual rates have been established. The contractual metering terms for each defined partition include a ceiling RPM value associated with a specific partition image that defines the number of licensed processors, the performance level of each processor, and the licensed processor configuration. The key of Table 1 includes a base RPM value (“Partition Image Base”) that represents the base value over which billable meter workload utilization information is gathered. A billing code value may be associated with the metered partition used by the central billing entity to establish a specific contractual price rate that is associated with the base/ceiling RPM pair. The billing code may take the form of an relative economic value indication as provided in the Table 1 price point byte in the Partition Image Descriptions. The price point byte allows up to sixteen relative economic values between zero and F (Hex) to be established for each partition. The four bit price point field may be used as the billing code for each partition.

A computer system issued with the features of the invention may be constrained by a system-wide “maximum performance level”, as determined by the sales contract. The maximum performance level applies to the system as a whole. As mentioned above, an economic value of the system is established with generation of a contract. The metering key will define separate “baseline performance levels” for each metering partition. Separate meters will be maintained for each partition to track actual usage above the baseline performance level.

Metering reports, discussed more fully below, will desirably include a digital signature that will allow software to be run at a billing location to verify that the contents of the meter report were not altered. In one embodiment, metering reports may be organized by partition, making it possible for the receiving end to get data for a particular partition, or all partitions.

In one embodiment, system users may have the ability to set a “governor”, which is a customer-defined “maximum performance level”, that may be set as low as the baseline performance or as high as the system-defined maximum performance level. The customer will be able to control how long a governor setting is in effect. Although metering key parameters are set in accordance to the contract with the customer, the parameters may be updated reflecting subsequent transactions with the customer. Such updates may desirably be performed as the computer system is running so that no downtime need be experienced by the system user.

Performance Redistribution

Software metering of the invention supports dynamic redistribution of partition performance as described previously. Performance in partitioned computer systems may determined by the use of a processor key. A processor key may be a metering key absent the relative economic value aspects present in the metering key. A processor key, not unlike a metering key, enables functionality within a partition and may establish processor performance limits within the partition. Generally, there may be one processor key per established partition. The processor key for the partition defines baseline and ceiling performance parameters, expiration date and a maximum time of use for the identified partition.

Performance redistribution may be accomplished using two techniques: (1) moving performance from one partition to another using an existing processor key (i.e., swapping images) and (2) changing the mix of partition performance characteristics by activating a different processor key (i.e., swap keys). Partition image licenses defined in processor licensing keys represent active partition instantiation licenses. As such, processor license keys may contain one or more partition images that comprise a partitioned computer system. The following examples illustrate the two performance redistribution techniques:

(1) Moving performance from one partition to another using an existing processor key:

In this example a processor key having two partition images may be used to transfer workload from one partition to another. Assume a single processor performance key licenses a computer system having two partition images identified as; (a) 2@49N/F and (b) 1@40N/7. The first image, 2@49N/F, licenses a partition to use two processors in a single power domain “N” running at a performance level of “49” that yields a capacity of 13,800 RPM and this capacity is economically evaluated at full price of “/F”. The second image, 1@40N/7, licenses a partition to use one processor in a single power domain “N” running at performance level of “40” that yields a capacity of 5,000 RPM, and this capacity is economically evaluated at half price of “/7”. Thus, in this example, the partitioned computer system consists of two partitions where the first partition is licensed with the image 2@49N/F and the second partition is licensed with the image 1@40N/7. Once a user accesses one of the images, she may redistribute the workload in one partition image to another partition image. The user can swap images to effectively transfer workload. The user may use one of the images to direct workload to be transferred between partitions. The results of the image swapping are that the workload in the one partition may be moved wholly or in part to the other partition. At the end of this reconfiguration, the images are swapped and the workload reconfiguration is executed quickly.

(2) Changing the mix of partition performance characteristics by activating a different processor key:

In this example, two or more keys may be used for a system, but the images may not be used to increase the economic value of the partitioned system. Each key may partition the system differently. Each key allowed for use on a system has the same economic value as any other key by the sum of economic values of each partition or image represented by that processor key. Using the dual image key defined in illustration (1) above, the two images, 13,800 RPM at full price and 5,000 RPM at half price, may be combined to form a single partition under a single key. The single or combined partition performance is economically equivalent to a system that consists of a single partition with a capacity of 13,800 RPM*100%+5,000 RPM*50% which equals 16,300 RPM*100% according to economic valuation aspect of the invention. Thus, the economical equivalent of the previous key having two images would be a processor performance key that licenses one partition image of the combination. The combined image key would be 2@57R/F, which licenses a partition to use two processors in dual power domains “R” running at performance level 57 that yields a capacity of 16,300 RPM. This capacity is economically evaluated at full price “/F”. After the combination is made, the user has two keys; the original dual image key and the single combined image key. From the combined, single key, a division may occur. If a user wishes to split his combined system consisting of a single partition running with the image license 2@57R/F into two new and different partitions, the user simply has to activate the previous key and/or image that specifies the two partition image license configuration. After the key is swapped, the user can then bring the second partition online with any relative proportion of processor workload. Note that using both method (1) and (2) above, all of the processor configurations are economically equivalent so no revenue loss is realized, while at the same time, the user is given flexibility to configure the partitions to accommodate his processing needs.

In a partitioned computer system, if an active partition is associated with a particular image license in the key, and that partition is stopped, then the associated image license is available for any other partition to use. Changing a partition processor image license may be performed dynamically. An operator may choose from an available partition image license or a stealable partition image license. An available image is one that can be acquired by a partition without affecting the image licenses of other active partitions. A stealable image is one that can be acquired by a partition, but may affect the partition image licenses of other active partitions. Activation of a partition processor image license may be performed by a system user.

In one embodiment, installed processor key information may be displayed on a system monitor detailing the system-wide performance licensing information and detailed processor performance information for all installed processor keys. An example set of installed key information is presented herein by example:

| | | | |
|---|---|---|---|
| 1 | SYSTEM MCN/MACH | 00ABE/0120 | PARTITION 7 ACTIVE KEY 2 ALT KEY NONE |
| 2 | | | METERING MODE 1, REPORT DAY 22, ID 3F93F465 |

| | | |
|---|---|---|
| 3 | IMAGES: CURRENT | 1@57N (RPM BASE 0 ACTUAL LIMIT 9356) |
| 4 | PARTITION | [5]4@46N (RPM MAX 22526 NON-METERING IMAGE) |
| 5 | | [6]8@56R/0 (RPM MAX 46437 BASE 40000) |
| 6 | | [7]4@53N/1 (RPM MAX 29365 BASE 0 TARGET LIMIT 10000) |
| 7 | AVAILABLE | 4@53N/1 (RPM MAX 29354 BASE 0) |
| 8 | STEALABLE | 8@56R/0 (RPM MAX 46437 BASE 40000) |
| 9 | | 4@46N (RPM MAX 22526 NON-METERING IMAGE) |
| 10 | | |

| | | | | |
|---|---|---|---|---|
| 11 | ID TYPE STATUS | DAYS/LEFT | EXPIRES | IMAGES |
| 12 | | | | |
| 13 | 2 PERM ACTIVE | | | A) 8@56R/0 (RPM MAX 46437 BASE 40000) |
| 14 | | | | B) 4@46N (RPM MAX 22526) |
| 15 | | | | C) 4@53N/1 (RPM MAX 29365 BASE 0) |

| 16 | | | METERING MODE 1, REPORT DAY 22, ID 3F93F465 | |
|---|---|---|---|---|
| 17 | | | IP1-ZKZQCB7EGP6PABAWHNKNTD87WXBBU54XGSN44HXS2GXM8UR3953D | |
| 18 | 3 TEMP EXHAUSTED | 3 0 | Dec. 31, 2003 | A) 8@56R/4 (RPM MAX 46437 BASE 40000) |
| 19 | | | | B) 6@56R/A (RPK MAX 39172 BASE 0) |

| | |
|---|---|
| 20 | METERING MODE 0, REPORT DAY 22, ID 3F9D390A |
| 21 | IP1-QS10ZKABKLJTQ1098094MVB0B9A0J0909TJ09JAKSLJFLASKJVAA |

Line 1 of the above example shows a system MCN (manufacturing control number, a unique system identifier), and a machine type. This matches the corresponding MCN and machine type specified in the metering key. Line 1 also indicates that the current partition is 7, the active key ID is 2, and there is no alternate key.

Line 2 of the above example indicates that active key 2 is a metering key running in mode 1; the unique contract identifier associated with this key is 3F93F465. The report day of the month is the 22^{nd}. On the report day at 2:00 am (UTC), a monthly meter report indicates that the meters accumulated against all partition images may be sent to a central billing address.

Lines 3-6 of the above example shows that one processor is currently online, running at processor performance level 57. The partition license for partition 7 indicates that the partition is licensed to run with 4 processors at processor performance level 53, and the desired limit for this partition is 10000 RPM (see line 6). System software attempts to achieve this desired limit using the currently active processors, and in this case set the maximum performance level to 57. Note the desired RPM level of 10000 was not achieved, but instead this partition is limited to 9356 RPM. If an additional processor is brought online, system software may adjust the processor performance level so the desired RPM level is maintained.

Lines 4-6 of the example indicate which partitions (partition number in brackets) are associated with the contract max/base RPM pairs defined in the key. For example, partition 5 is licensed with the 4@46N image; this image is non-metering and has a maximum RPM value of 22526. In contrast, partition 7 (the local partition) is licensed with the 4@53N image; this image is metering with a maximum RPM value of 29365 RPM and a base RPM value of 0. Also the operator has most recently specified that this partition should not exceed a workload value of 10000 RPM. “TARGET LIMIT” values may be displayed for the local partition. For metering partitions, the value displayed after the image (e.g., “/1”) indicates the billing code associated with this partition image. This billing code conveyed with the metering images in the monthly meter report sent to a central billing location, and is used to associate a contractual price rate with the billable utilization for that partition.

Line 7 of the example displays all images that can be activated on this partition without affecting the partition processor image licenses of other partitions.

Lines 8-9 of the example display all images that can be activated on this partition but will affect the partition processor image licenses of other partition. For example, the operator can activate the 8@56R image for partition 7, but partition 6 (the current user of this image) will automatically acquire the only available image, 4@53N.

Lines 13-end of the example display details information for all keys installed on the system, which includes the key's ID, type, status, days the key can be active, days left that the key can be active, defined images, metering mode, report day, contract identifier, and the encrypted key string. The key's ID is a value that ranges from 1 to 999. Valid key types are PERM, TEMP, or DR. Valid key statuses are ACTIVE, ALTERNATE, AVAILABLE, EXPIRED, EXHAUSTED, or DISABLED. Temporary and disaster recovery keys specify the number of days that the key can be active and the number of days left that the key can be active. In this example, key 3 had 3 days that the key could be active and it currently has 0 days left. All keys may have an expiration date. In this example, key 2 does not have an expiration date, while key 3 has an expiration date of Dec. 31, 2003.

For each key, the licensed images may be displayed. Each image may be preceded by a letter that corresponds to an ordinal number. As stated before, the value displayed after the image (e.g., “/1”) indicates the billing code associated with this image. This billing code conveyed with the metering images in the monthly meter report sent to a central billing location, and is used to associate a contractual price rate with the billable utilization for that partition. Each image displays the associated contract max RPM defined in each image. For metering images, the base RPM may also be displayed. The metering mode is displayed for each key. In this example, key 2 is running mode 1 and key 3 is running mode 0. A report day is displayed for all installed metering keys along with the unique contract identifier associated with each key. The last line for each key is the encrypted key string used to install the key.

As one aspect of the invention, processor keys and metering keys may be used to define partitions with a computer system. Each computer system is defined to have a total economic value resulting from the sum of the economic values of each of its partitions. The use of metering keys specifically includes the aspect of economic value by providing a billing code in the form of a price point byte in the “partition image description” field as described above in relation to Table 1. Although processor keys may be viewed as merely metering keys without specific reporting information and explicit economic value information, the use of processor keys may still comport with the concept of a fixed economic value for a system as set up by a customer contract for a partitioned computer system.

Metering Reports

As mentioned briefly above, in one embodiment, metering reports are automatically transmitted from the partition meter to the central billing location via electronic mail.

Further according to this aspect of the invention, one feature of a billing report is that a digital signature is sent with the billing report to authenticate the source of the report. This digital signature is read at the central billing location and the origin of the report is then verified. This digital signature is useful in the context of the present invention to prevent fraud in reporting partition performance usage.

Preferably, monthly meter utilization reports are automatically sent to the central billing e-mail address on a report day defined in the currently active metering key. As an option, the computer system user may request a utilization reports for his own use in monitoring processor usage. Interim meter utilization reports may be preferably sent automatically to billing on a periodic interval (e.g., hourly, daily, etc.) specified in the currently active metering key. The following is an example of a metering utilization report.

| 1 | From: (e-mail transmitting address) | |
|---|---|---|
| 2 | Sent: Friday, November 21, 2003 9:00 PM | |
| 3 | To: (e-mail receiving address) | |
| 4 | Subject: 00ABE/0420 MONTHLY METER REPORT | |
| 5 | | |
| 6 | | |
| 7 | System MCN/MACH | 00ABE/0420 |
| 8 | Report Type | Monthly |
| 9 | Version | 2 |
| 10 | Interval | Wed, Oct 22, 2003 02:00:34 to |
| 11 | (UTC) | Sat, Nov 22, 2003 02:00:30 |
| 12 | | |

| | | | |
|---|---|---|---|
| 13 | Key 3F93F465[1] | Actual Utilization | Avg Workload |

| 14 | Time | 2,678,396 | seconds | |
|---|---|---|---|---|
| 15 | Image 8@56R/0 | | | |
| 16 | Baseline | 107,135,840,000 | RPM*sec | 40,000 RPM |
| 17 | Maximum | 124,376,675,052 | RPM*sec | 46,437 RPM |
| 18 | Total Used | 86,097,039,420 | RPM*sec | 32,145 RPM |
| 19 | Metered | 1,407,204,467 | RPM*sec | |
| 20 | Billable | 535 | RPM*month (standard) | |
| 21 | Image 4@46N | Non-Metering Partition Image | | |
| 22 | Image 4@53N/1 | | | |
| 23 | Baseline | 0 | RPM*sec | 0 RPM |
| 24 | Maximum | 78,651,098,540 | RPM*sec | 29,365 RPM |
| 25 | Total Used | 13,489,322,823 | RPM*sec | 5,036 RPM |
| 26 | Metered | 13,489,322,823 | RPM*sec | |

| | | | |
|---|---|---|---|
| 27 | Billable | 5,129 | RPM*month (standard) |

In the example monitoring report above, line 1 is the sending email address. Line 2 is the timestamp when the message was sent. Line 3 is the destination email address. Line 4 is the subject of the email address. Line 4 also specifies the system MCN and machine type along with the type of metering report, interim or monthly. In this example this is a monthly metering report. Line 7 specifies the system MCN and machine type. Line 8 specifies the report type, interim or monthly. Line 9 specifies the metering version. In this example the metering version is 2. Lines 10-11 specify the report interval in universal time code (UTC). In this example the report interval is from Oct. 22, 2003 2:00 to Nov. 22, 2003 2:00. Line 13 specifies the metering key used during the report interval. The metering mode is also displayed for each key. In this example, key 3F93F465 is running mode 1. Line 14 specifies the amount of time this key was used during the report interval.

Lines 15-the end specify, for each key, the licensed images. For metering images, the value displayed after the image (e.g., “/1”) indicates the billing code associated with this image. This billing code conveyed with the metering images in the monthly meter report sent to the central billing is used to associate a contractual price rate with the billable utilization for that partition. Non-metering images, such as 4@46N, display “Non-Metering Partition Image.” However, metering images may display the time the key was in use, the actual utilization in RPM*seconds for the baseline, maximum, used, billable RPMs and the average workload in RPM for the baseline, maximum, and used RPMs. For example, image 8@56R was in use for 2,678,396 seconds and the actual baseline utilization was 107,135,840,000 RPM*seconds and the average workload was 40,000 RPMs.

As mentioned previously above, metering reports are generated on a partition level and are identified with a specific partition in a computer system. Metering reports enable the computer vendor to bill the user for utilization of processor performance within a partitioned system according to the economic value established by the contract. The billing code, partition identifier, metered performance and the correlation of these attributes at the central billing location enable a partitioned system to be billed according to the economic value constraints specified by the computer system contract.

As mentioned above, while exemplary embodiments of the invention have been described in connection with various computing devices, the underlying concepts may be applied to any computing device or system in which it is desirable to implement an economic value-based metering and billing method. Thus, the methods and systems of the present invention may be applied to a variety of applications and devices. While exemplary programming languages, names and examples are chosen herein as representative of various choices, these languages, names and examples are not intended to be limiting. One of ordinary skill in the art will appreciate that there are numerous ways of providing object code that achieves the same, similar or equivalent systems and methods achieved by the invention.

As is apparent from the above, all or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., instructions). This program code may be stored on a computer-readable medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer or server, the machine becomes an apparatus for practicing the invention. A computer on which the program code executes will generally include a processor, a storage medium readable by the processor (including volatile and non-volatile memory and/or storage elements), at least one input device, and at least one output device. The program code may be implemented in a high level procedural or object oriented programming language. Alternatively, the program code can be implemented in an assembly or machine language. In any case, the language may be a compiled or interpreted language.

The present invention may also be embodied in the form of program code that is transmitted over some transmission medium, such as over electrical wiring or cabling, through fiber optics, over a network, including a local area network, a wide area network, the Internet or an intranet, or via any other form of transmission, wherein, when the program code is received and loaded into and executed by a machine, such as a computer, the machine becomes an apparatus for practicing the invention.

When implemented on a general-purpose processor, the program code may combine with the processor to provide a unique apparatus that operates analogously to specific logic circuits.

While the present invention has been described in connection with the preferred embodiments of the various figures, it is to be understood that other similar embodiments may be used or modifications and additions may be made to the described embodiment for performing the same function of the present invention without deviating therefrom. Therefore, the invention should not be limited to any single embodiment, but rather should be construed in breadth and scope in accordance with the appended claims.

1. A computer-readable medium having stored thereon a data structure for a metering key, the data structure comprising:
a first data field containing identification information wherein the identification information uniquely identifies at least one partition for a computer system;
a second data field containing a processor baseline performance value; and
a third data field containing a billing code for the partition;
wherein the metering key is used to enable reporting of measured processor performance in the at least one partition and wherein the reporting is correlated with the billing code corresponding to a relative economic value of the partition in the computer system.

2. The data structure of claim 1, further comprising a fourth data field comprising a metering reporting interval and reporting duration.

3. The data structure of claim 1, further comprising a fourth data field comprising a digital signature used in conjunction with the reporting of measured processor performance to verify authenticity.

4. The data structure of claim 1, wherein the product of the baseline performance value and the relative value of the partition define an economic value for the partition, and wherein the sum of the economic values of all the partitions define a total economic value for the computer.

5. A method of monitoring processor utilization in a computer comprising multiple partitions, the method comprising:
assigning each partition a baseline performance value and a relative value, wherein the relative value comprises a value of a class of tasks performed in the partition relative to the values of classes of tasks performed in each other partition, wherein the product of the baseline performance value and the relative value of the partition define an economic value for the partition, and wherein the sum of the economic values of all the partitions define a total economic value for the computer;
associating a digital metering key with each partition, wherein the digital metering key associated with a partition comprises:
a first data field containing identification information that uniquely identifies the partition;
a second data field containing the baseline performance value of the partition; and
a third data field containing a billing code for the partition;
measuring processor utilization within one of the partitions in accordance with its respective digital metering key;
reporting the measured processor utilization within the one partition using a digital signature to authenticate the data reported; and
measuring and reporting the measured processor utilization of other partitions in the computer, wherein respective digital metering keys and digital signatures are used in each of the other partitions.

6. A computer-readable medium having instructions therein, executable by a computer having multiple partitions to perform a method of monitoring processor utilization in a computer comprising multiple partitions, the method comprising:
assigning each partition a baseline performance value and a relative value, wherein the relative value comprises a value of a class of tasks performed in the partition relative to the values of classes of tasks performed in each other partition, wherein the product of the baseline performance value and the relative value of the partition define an economic value for the partition, and wherein the sum of the economic values of all the partitions defines a total economic value for the computer;
associating a digital metering key with each partition, wherein the digital metering key associated with a partition comprises:
a first data field containing identification information that uniquely identifies the partition;
a second data field containing the baseline performance value of the partition; and
a third data field containing a billing code for the partition;
measuring processor utilization within one of the partitions in accordance with its respective digital metering key;
reporting the measured processor utilization within the one partition using a digital signature to authenticate the data reported; and
measuring and reporting the measured processor utilization of other partitions in the computer, wherein respective digital metering keys and digital signatures are used in each of the other partition.
